(19) United States
(12) Patent Application Publication
(10) Pub. No.: US 2003/0033198 A1
(43) Pub. Date: Feb. 13, 2003

(54) Method and system for providing prepaid phone advertising

(76) Inventors: John F. Flannery, Cummaquid, MA (US); Edward C. Sweeney, Keene, NH (US); Mark W. Wheeler, Laguna Hills, CA (US)

Correspondence Address: Kevin Buford, Holland & Knight, LLP, Suite 700, 1600 Tysons Boulevard, McLean, VA, 22102, US

(21) Appl. No.: 09/924,649

(22) Filed: Aug. 8, 2001

(51) Int. Cl. G06F 17/60

(52) U.S. Cl. 705/14

(57) ABSTRACT

A method and system for providing advertisement services to a user of pre-paid telephony services includes communicating a PIN via a telephone link to a voice response unit, using a PIN-based index of pre-recorded services to generate a valid access request and matching the PIN link to an existing pre-recorded audio service. The person accessing the voice response unit can control telephonic access to the server or merchant who is offering the service or advertisement via telephone keypad instructions transmitted to the voice response unit and passed on to the data management server. The pre-recorded audio services may be, e.g., stored on a server as digital audio source, several control data fields including the PIN range associated with that message, a field for a dial-to number to the Audio Services Provider/Owner and fields to contain accounting numbers. The owner of the prepaid calling card may also be allocated additional call value or call time increments as a result of their selection of an option to receive additional, longer or other audio services during their call sequence.

### FIELD OF THE INVENTION

The present invention is in the field of communication systems, and in particular those communications systems using prepaid calling “cards” for delivery of audio services to wired and wireless telephony systems.

### BACKGROUND OF THE INVENTION

Consumer use of prepaid telephone calling cards to make voice calls is growing dramatically in the United States. Prepaid services for both “land line” and cellular methods of communications have long been a significant part of the telecommunications business in Europe. Globally there are billions of prepaid telephone cards sold each year. These prepaid telephone cards come in a range of values, from as little as to hundreds of dollars for each card. The prepaid card is an instrument of value, not of telephone talk time, and the value is translated into some number of increments of talk time depending on the cost and calling plan associated with each individual card and the end points of the calls made by the user. For example, five dollars worth of local calls at $0.10 per minute with no connect charge is considerably more talk time than long distance calls from the United States to India at $1.00 per minute with a $0.50 connect charge.

Prepaid telephone cards come in two basic variants, but both work essentially the same way. One variant is where the calling party actually purchases and receives a physical card. This card can be plastic, similar to a credit card, or simply a paper or cardboard card, which may be the same size as a credit card for convenience. These cards are generally purchased at bricks-and-mortar retailers, but are also distributed by mail, through catalogs on the Internet, and at a number of other retail environments. On the card is imprinted three key numbers, (1) the toll free number of the telephone switch and (2) a Personal Identification Number (commonly referred to as a “PIN” in the industry) and (3) the value in monetary units of the card. The second variant is where the calling party only receives notification of the toll free number to the telephone switch, the PIN and the value associated with that card. This notification can be made at the time of purchase on the Internet, through receipt of an e-mail, letter or similar communication after purchase, or through simple activation of a pre-purchase solicitation that is then charged to some payment medium. As one can appreciate, the two essential elements are the toll free telephone number of the telephone switch providing the telephone connections, and the PIN that identifies the “card” to the telephone switch accounting system.

The telecommunications services activated by these cards are typically accessed by touchtone telephones and controlled through use to the tone buttons on the telephone set. In some countries certain buttons are inactivated after the initial dial sequence and are unavailable to control the functionality of prepaid telephone cards. For example, on many public telephones in the United Kingdom, the number key (“#”) is disabled after the first number sequence is dialed and does not produce a tone when depressed. Also, prepaid telephone cards do not work with pulse-dial telephones unless the card plan provides for access to a service person to place the calls.

The communication system utilized in a prepaid telephone service may includes (a) the telephone set of the calling party (e.g., a home or office handset, a coin-operated call box, or a cellular telephone); (b) the services provided by a local service provider including wires, routers, switches, traffic management computers and others; (c) the services provided by the inbound long distance carrier including wires, routers, switches, traffic management computers and others; (d) the services provided by a local service provider where the switch is located including wires, routers, switches, traffic management computers and others; (e) the services of the outbound long distance carrier from the switch to the local service provider of the called person including wires, routers, switches, traffic management computers and others; and (f) the telephone set of the called party. The local and long distance service providers use land or terrestrial lines of metal (twisted copper pair, coax or the like) or fiber, microwave communications, satellite communications in any and all combinations depending on their installed equipment and load routing and management computer systems.

Despite the broad success of prepaid phone cards, advertising has not been focused on the caller as they make their prepaid calls. The extent of such advertising has been the use of graphic advertising imprinted on the card, or perhaps just a branding logo; but there is no connection between the message of the card's advertising and the process of making the telephone call. There has not been any attempt to make use of the finite amount of “dead” or “idle” time that is present as a call is first being connected.

Accordingly there remains an opportunity to make use of this dead or idle time to deliver an audio service relating to the products and services being provided by the vendor or sponsor of the prepaid card.

The present invention satisfies this need by delivering one or more of a set of targeted audio services to the calling party, and provides them with the opportunity to be connected to the Audio Services Provider/Owner following their calling sequence.

### SUMMARY OF THE INVENTION

The present invention is generally directed to a communication system for providing access to pre-recorded audio services messages via standard wireline and wireless telephones through the use of a telecommunications switch or router with a voice response unit in communication with a server system, where the server system retrieves one of a number of pre-recorded audio services from a data base containing the pre-recorded audio services.

In a first, particular embodiment of the present invention, a communication system is established in which a PIN based index of pre-recorded services is used to generate a valid access request when a Personal Identification Number (“PIN”) communicated via a telephone link to the voice response unit matches the PIN link to an existing pre-recorded audio service. The person accessing the voice response unit can control telephonic access to the merchant who is offering the service or advertisement via telephone keypad instructions transmitted to the voice response unit and passed on to the data management server.

In a second, separate embodiment of the present invention, the pre-recorded audio services are stored on a server as digital audio source, several control data fields including the PIN range associated with that message, a field for a dial-to number to the Audio Services Provider/Owner and fields to contain accounting numbers. The audio message file is encoded with instructions and stored in a compressed format which is then retrieved as digital data by the server and decompressed before the pre-recorded audio message is transmitted to the telephone link of the calling party, by the voice response unit.

In a third, separate embodiment of the present invention, the owner of the prepaid calling card may be allocated additional call value or call time increments as a result of their selection of an option to receive additional, longer or other audio services during their call sequence.

Accordingly, the present invention provides a communication system and method for accessing audio services in response to use of a prepaid phone card.

This and further objects and advantages will be apparent to those skilled in the art in connection with drawings and the detailed description of the preferred embodiment set forth below.

### BRIEF DESCRIPTION OF THE DRAWINGS

FIG. 1 is a block diagram that illustrates a communication system according to the preferred embodiment of the present invention.

FIG. 2 is a flowchart that illustrates a process of the first embodiment by which a system accepts an incoming call, validates the PIN and captures the call-to number from the calling party.

FIG. 3 is a flowchart that illustrates a process of the first embodiment by which a system selects the Audio Services to be played, plays the Audio Services and performs some accounting functions.

FIG. 4 is a flowchart that illustrates a process of the first embodiment by which a system allows the calling party to select a connection to the Audio Services Provider/Owner or not and then monitors the cost of the call to the called-to party.

FIG. 5 is a flowchart that illustrates a process of the first embodiment by which a system monitors the sequence of events while the calling party and the called-to party are connected.

FIG. 6 is a flowchart that illustrates a process of the first embodiment by which a system performs the functions of disconnecting the call and when the calling-party selects to or not call the Audio Services Provider/Owner and the process by which the calling party can select to listen to a longer or new Audio Service and receive additional call value for so doing.

FIG. 7 is a flowchart that illustrates a process of the first embodiment by which a system connects the calling party to the Audio Services Provider/Owner, monitors the call and performs some call accounting functions.

FIG. 8 is a flowchart that illustrates a process of the first embodiment by which a system monitors a connected call and allows the calling party to reconnect if desired and performs some call accounting functions.

FIG. 9 is a flowchart that illustrates a process of the first embodiment by which a system disconnects the calling party when the Audio Services Provider/Owner is not contacted.

FIG. 10 is a flowchart that illustrates a process of the first embodiment of an exception process when the calling party has entered an invalid PIN more than the allowed number of tries.

### DETAILED DESCRIPTION OF THE PREFERRED EMBODIMENT

In a preferred embodiment of the invention, the calling party is supplied a toll free number to initiate the calling process and a unique number or PIN that will identify him, or her “card,” to the telephone switch accounting system. The calling party may have a card supplied by the vendor, or may not. The card may or may not be embossed or equipped with a magnetic stripe or a computer chip. It will have the toll free number, the PIN and other product identification and marketing information imprinted and/or embossed on the card. In the non-card situation, the calling party will have been supplied the toll free number and PIN by any of a number of means (including but not limited to a letter, e-mail, notice on a website, a solicitation telephone call, or other means of communication). The prepaid card/account may be a “one time card,” such that additional value cannot be added to it by any methodology (i.e., the card is “used up” when the monetary value of the card is exhausted); or the card/account may be able to have value added to it by various means. In all cases, the calling party receives or is otherwise credited with a certain value of prepaid telephone “talk time” which will be in some increments of value (e.g. $5, $10, $25, $50).

A process in accordance with the invention may start when the calling party dials the supplied toll free number and is connected to the telephone switch that is providing the call minutes for that card. The calling party is prompted by a prerecorded prompt (preferably a voice prompt) to enter the PIN number. Upon receipt of a valid PIN number, the telephone switch delivers a pre-selected, prerecorded ad or audio service to the caller. The ad or audio service can be of varying length, and can promote one or more vendors' services, advertisements or products. The content of the ads is preferably audio, but can also be a mixture of video for those users having video enabled communications devices (cell phones, satellite phones, alphanumeric displays, or even monitors used with voice over IP, ATM or other network-based services). The telephone switch will provide the functionality to allow, e.g., (i) varying lengths of ad or audio services; (ii) a variable selection of services, where the variation can be delivered in either random or pre-specified sequences and periodicity (e.g., once per communication session (from the user's perspective), once per defined period (e.g. a week) or once per issued PIN); and (iii) ad or audio services targeted to a specific subset of phone “cards”, based on a range of the PIN numbers which were allocated to that set of services. The typical audio “spot ad” will be short, preferably less than fifteen seconds. The calling party is then allowed the opportunity, e.g. by audio prompt, to input one of the numbers on their dial-pad which indicates their choice of whether or not to be connected, during or after the call, to the advertiser to whose message they have just listened.

In the typical case, the calling party is next prompted by audio prompt to input the telephone number of the call-to party, to whom they wish to speak. The telephone switch checks the value remaining on the “card” and informs the calling party by audio prompt of the amount of time or the value, or both, remaining on the card, and connects to the called-to party if sufficient funds are available to make at least a one (1) call unit connection. When connected, the telephone switch remains in the calling circuit, counting the minutes or fractions of minutes that the calling party is connected to the called-to party. At the conclusion of the call the telephone switch deducts the value of the used call minutes (or fractions of minutes) from the value on that “card”. Then, if the calling party has opted to be connected to the vendor who supplied the audio service, the telephone switch connects the calling party to the vendor's inbound telemarketing center or other destination indicated by the number assigned to the audio service.

The telephone switch also performs a number of accounting functions related to each call, each “card”, each audio service, each vendor providing the service, and for all calls placed by the switch.

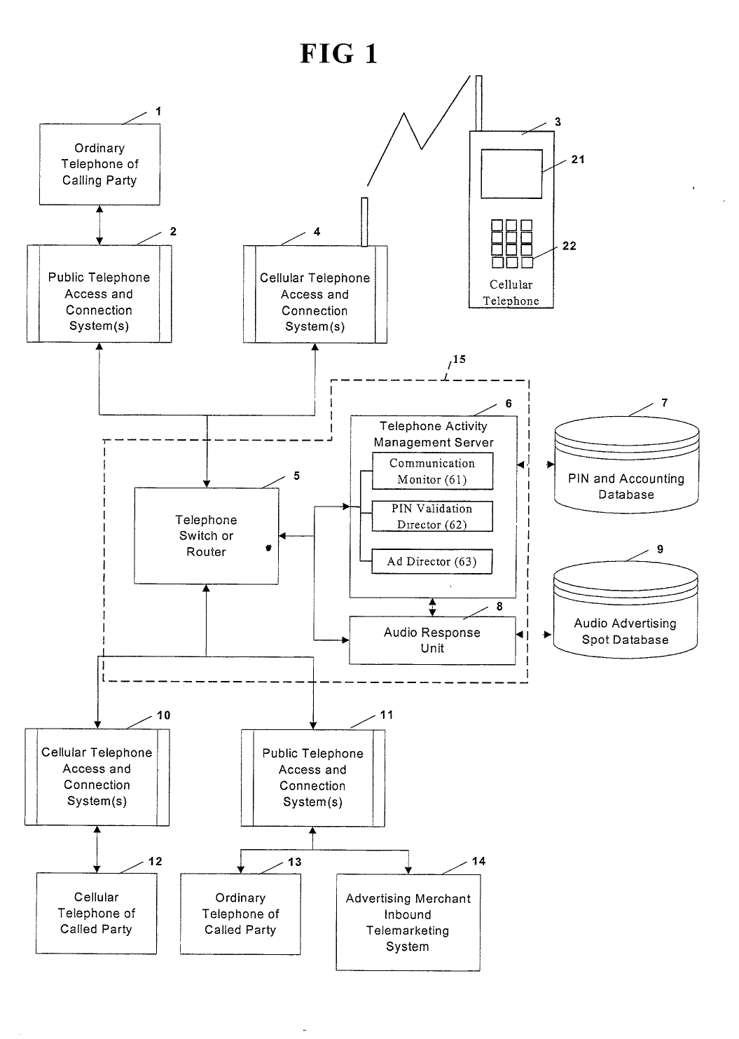

Turning now to FIG. 1, a communication system in accordance with the preferred embodiment is illustrated. This system includes a calling party's telephone 1 connected to the public telephone access and connection systems 2, or their cellular telephone 3 connected to the public cellular switching and connection systems 4, both of which connect to a service control unit 5. As one skilled in the art will appreciate, any one of a variety of communication units (satellite phones, speakers connected to computers, wireline or wireless), connecting networks (cable telephony, voice over IP, switched or routed data networks, wired or wireless), and connecting means (e.g., switches, routers and the like) may be used in implementing the invention. Service control unit 5 is typically a telephone switch, but it may also be a router or other processing device controlling the caller's use of the telephony system. Connected to switch 5 is an information support and control server 6, a PIN and accounting database 7, a voice response unit 8, and an Audio Advertisement Services Database 9. The PIN and accounting database 7 verifies that the PIN is valid, and the amount of value remaining for the owner of the PIN to use. The voice response unit 8 translates data into intelligible voice prompts that the caller can understand; when the caller is connected via a device with video capability (e.g., a video phone, third generation cellular phone, or computer) any response unit 8 may instead be a video or other data response unit translating the prompt information into a format that can be presented to the user. Similarly, while the preferred embodiment of the Advertisement Service Database 9 stores advertisements for audio playback via a voice response unit 8, database 9 may store advertisement data in any format (e.g., ASCII text, binary, video, MP3) that can subsequently be forwarded and communicated to the caller. The telephone switch 5 is also connected to the called parties' ordinary telephone 11 via the public telephone switching and connection system 10 (which may be the same as system 2), the called party's cellular telephone 13 via the public cellular switching and connection system 12 (which may be the same as system 4), and when triggered, the inbound telemarketing service of the Audio Services Provider/Owner 14.

The most common implementation of the invention is expected to utilize a telephony switch 5 together with a management server 6. However, any form of communication processor 15 may be used, as long as the processor 15 is serving to verify the PIN/card and mediate the advertising services. Thus, in the case of FIG. 1 communication processor 15 may also include a routing server 5 in lieu of a switch, and may also include the programming necessary for the telephone activity management 6 and audio response unit 7; the same server platform may also include personal identifier data store (e.g., PIN database) 7 and Ad data store (e.g., audio spot advertising database) 9. The stored advertising could be digital or analog; binary, audio, or multimedia; and response unit 8 could be one or more combinations of data translation algorithms and/or a data25 voice converter (e.g., a PCM codec).

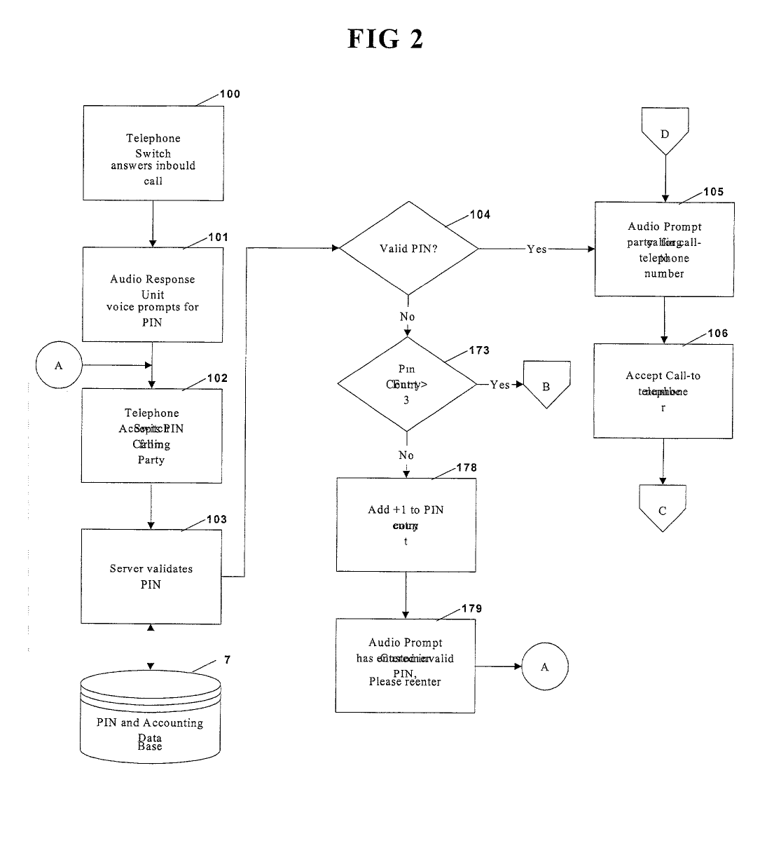

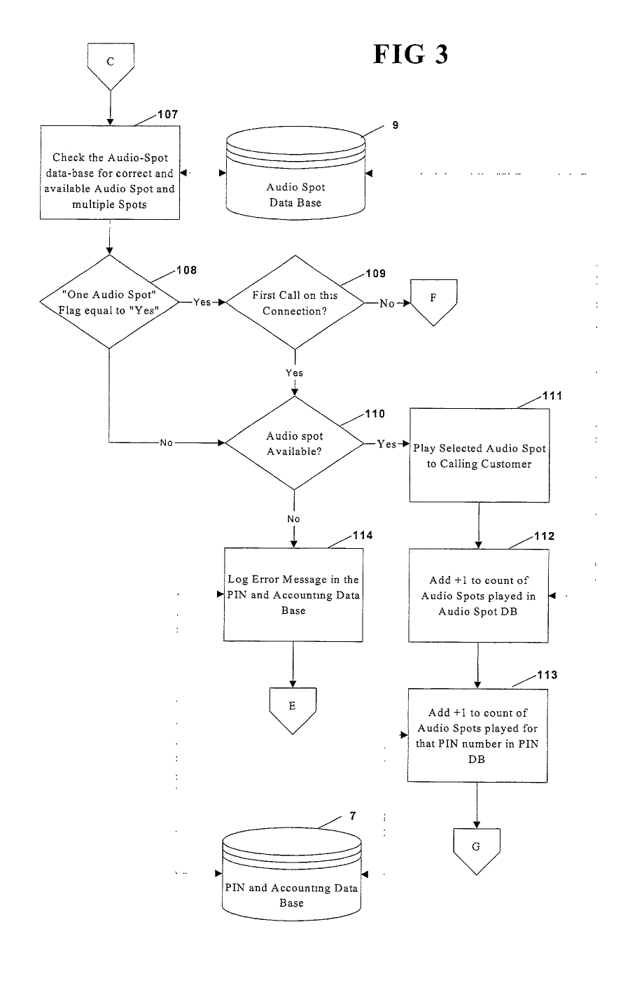

FIG. 2 is a flowchart illustrating a series of process that occur after the calling party dials the toll free number of the telephone switch 5. When contacted, the telephone switch 5 accepts the incoming call from the calling party 100 and alerts the Telephone Activity Management Server 6. The Audio Response Unit 8 provides the calling party with an audio prompt to enter the PIN number of the calling card (step 101), and accepts the PIN from the calling party when entered (step 102). The PIN information is then provided to the server 6, which validates the PIN by accessing a preloaded PIN data base (step 103). If the PIN is on the PIN data base, has been activated and is valid (step 104), the Audio Response Unit 8 prompts the calling party for the call-to telephone number (or such other identifier that is associated with the call-to telephone for establishing communications) (step 105), and the telephone switch accepts the call-to telephone number that has been entered by the calling party (step 106). If the PIN is invalid and the calling party has not entered an invalid PIN three times (step 173), the server increments the count of invalid PIN entries by the calling party (step 178) and the Audio Response Unit provides an audio prompt that the calling party has entered an invalid PIN and that they should reenter a valid PIN (step 179). The telephone switch accepts the PIN and reenters the logic to check the PIN that has been entered at step 102. The telephone procedure then continues processing with the logic of FIG. 3.

FIG. 3 illustrates a process in which the server selects the Audio Advertising Services to be played to the caller. When a PIN is provided, server 6 accesses the Audio Services Data Base 9 and, based on the PIN number, verifies that an Audio Advertising Service is available and checks to see if the “One Audio Spot” flag is set. If the “One Audio Spot” flag is set to Yes 108 and it is not the first call on this connection 109 then the server 6 initiates the calling sequence 118, effectively bypassing the Audio Advertising Services delivery. If the “One Audio Spot” flag is not set to Yes 108 then multiple Audio Advertising Services can be delivered to the caller if multiple calls are placed during the calling sequence. Server 6 then checks to see if an Audio Advertising Service is available 109. If not, the server 6 logs an error message in the PIN and Accounting Data Base 114 and initiates the calling sequence 118, effectively bypassing the Audio Advertising Services delivery. If so the server then prompts the Audio Response Unit 8 to play the Audio Advertising Services to the calling party (step 111). The server 6 then increases the count, in the Advertising Services Data Base 9, of the number of Advertising Services played to the calling party (step 112). The server 6 also increases the count, in the PIN and Accounting Data Base 8, of the number of Audio Advertising Services played to the calling party (step 113).

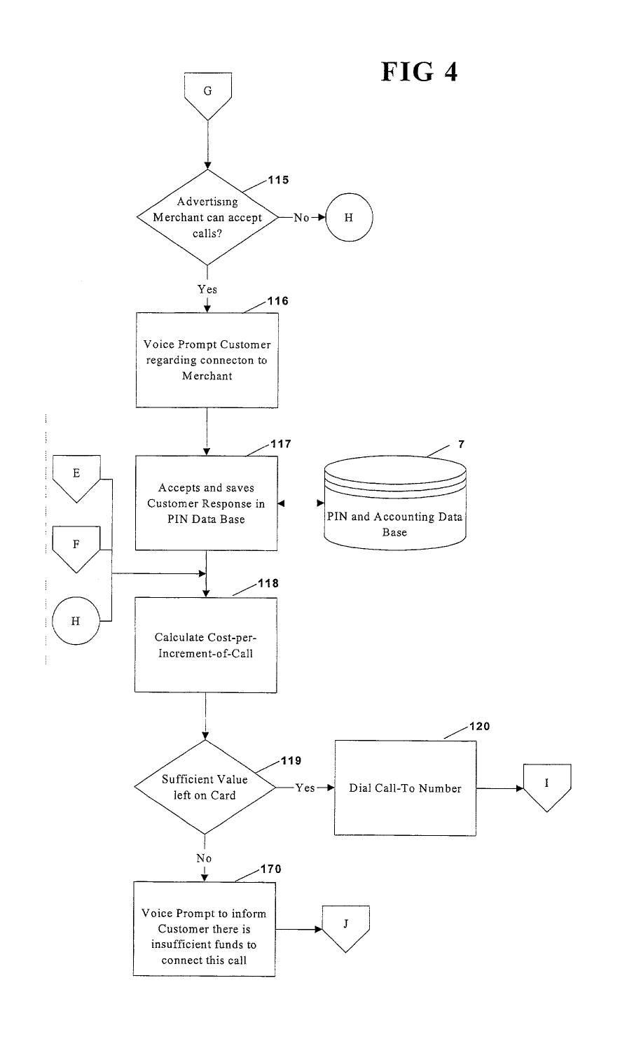

Next, in FIG. 4 the server 6 checks to see if the advertising Services Provider/Owner can accept inbound calls from the calling party, preferably at the end of the calling sequence (step 115). If the Services Provider/Owner can, server 6 initiates the Audio Response Unit 8 to query the calling party (e.g., by voice or touchtone prompt) to see if they want to be connected to the Audio Services Provider/Owner at the end of the calling sequence (step 116). Alternatively, instead of waiting until the end of their call, the caller can also be provided with a choice of when to connect, e.g., “Please press 1 to be connected immediately, and press 2 to be connected at the end of your call.” Likewise, the spot ad message and further connections could both be delayed until after the user finishes his call sequence, if desired. In the preferred approach, the server 6 saves the calling party's response for later use, e.g., in the PIN and Accounting Database (step 117), and then calculates a cost per increment of call time (step 118). If the user does not select any Services, or if the Services Provider/Owner cannot accept voice calls or other communications (e.g., some combination of audio (speaker/keypad) and visual (touch screen) input/output via the user's phone) (step 115) the server initiates the cost per increment of call time calculation (step 118). The server then compares the value left on the calling card (step 119) and if there is sufficient value to complete one call increment, dials the call-to number (step 120). If there is not sufficient value remaining for the calling card to complete one call increment, the server prompts the Response Unit 8 to inform the calling party that they have insufficient funds on their card to complete a call to the call-to number (step 170).

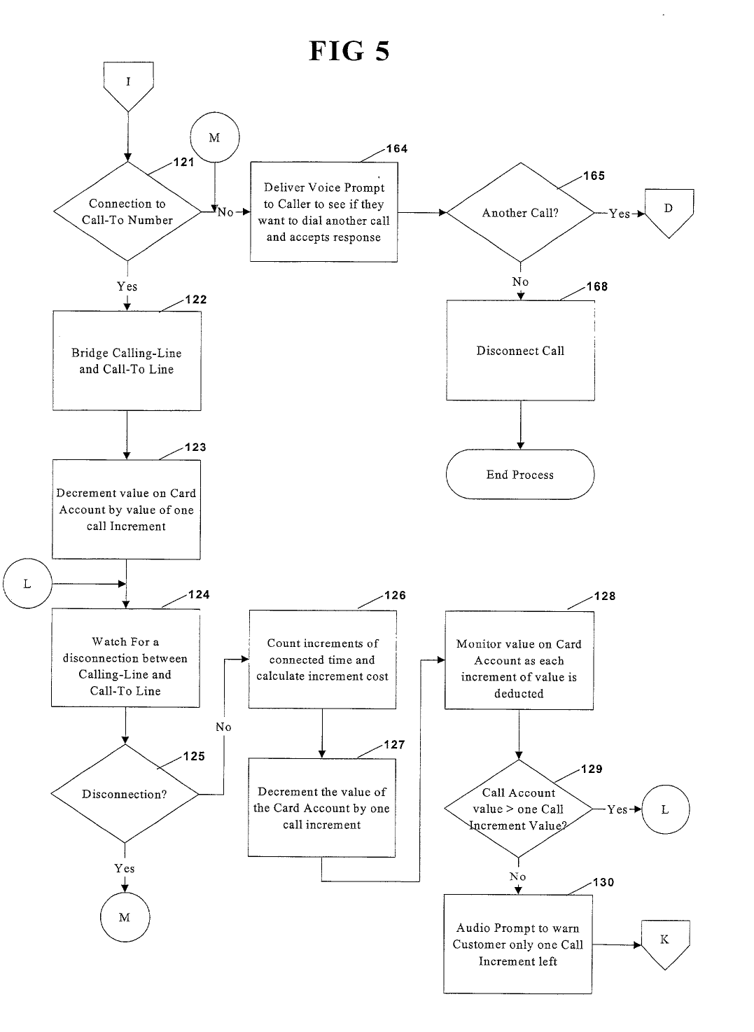

FIG. 5 illustrates the connection and call management sequence. This sequence is started by monitoring to see if a connection is made to the call-to number (step 121), and if so, connects the calling party and the call-to party (step 122). The server 6 monitors the call and decreases the value on the calling card by the value of one call increment for each call increment that accumulates during the connected call (step 123). The telephone switch 5 continually monitors the connected call for a disconnection (step 124) and if there is no disconnection (step 125), server 6 continues to count increments of call time (step 126) and decrements the value on the calling card by each value increment (step 127) and monitors the value on the calling card as each value increment is decremented (step 128); if the value on the calling card is still greater than one call increment's value, switch 5 continues to monitor for a disconnection (step 124). If no connection is made to the call-to number (step 121) the server 6 prompts the Audio Response Unit 8 to question the calling party to see if they desire to make another call (step 164), evaluates the decision (step 165), and if the calling party has chosen not to make another call, disconnects the call (step 168). If the user has previously responded that she wants to be connected to the Service Provider of the spot ad, the communications processor connects the user to the Service Provider at this time.

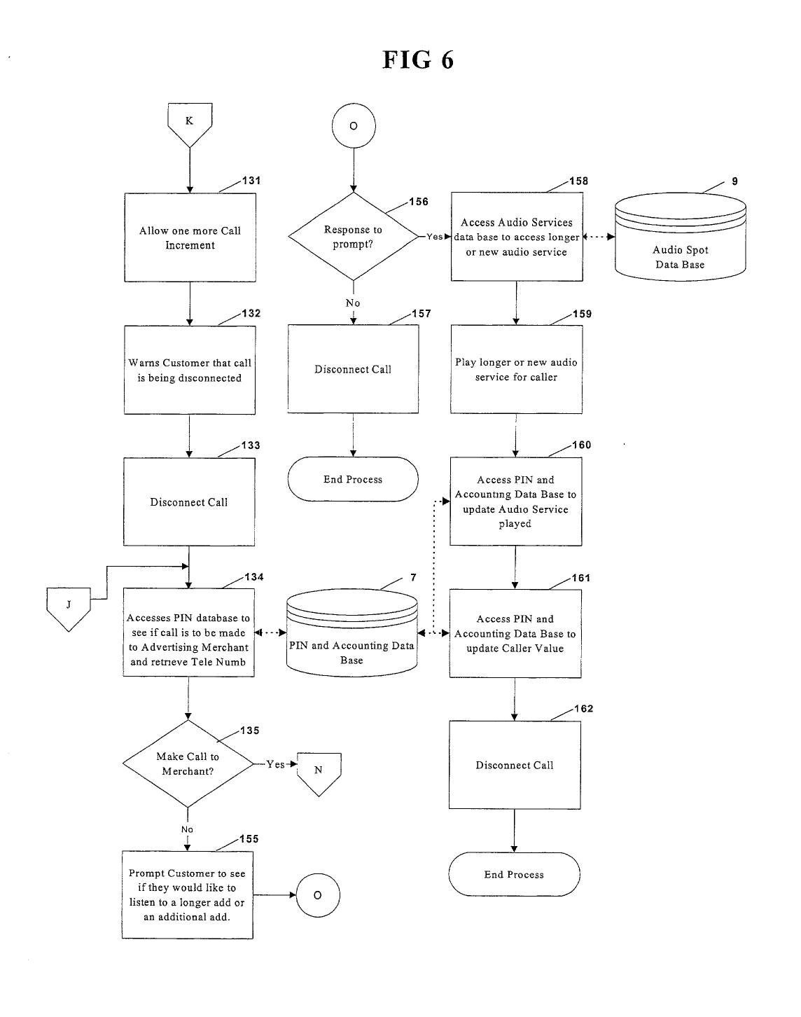

Turning now to FIG. 6, a preferred embodiment for connection to the ad services is shown. The server 6 monitors the call and allows a final increment of call time to occur (step 131), and warns the calling party that the call is about to be terminated (step 132). The server prompts the telephone switch 5 to disconnect the call (step 133) and then accesses the PIN database to see if a call is to be made (e.g., in response to a user selection earlier) to the Audio Services Provider/Owner (step 134). If so (step 135) the server prompts the telephone switch to initiate the call. If not (step 155) the Audio Response Unit 8 prompts the calling party to see if the calling party would like to listen to a new or longer Audio Service. If the response (step 156) is negative, the server prompts the telephone switch to disconnect the call (step 157). If the response (step 156) is affirmative, the server 6 accesses the Audio Spot Data Base to select a new or longer service to play to the calling party (step 158). The Audio Response unit then delivers the new or longer audio service (step 159). The server 6 then accesses the PIN and Accounting Data Base 9 (step 160) to update the count of the Audio Service that has been delivered. The Server again accesses the PIN and Accounting Data Base 9 (step 161) to update the value of the calling party's card. The server 6 than prompts the telephone switch to disconnect the call (step 162).

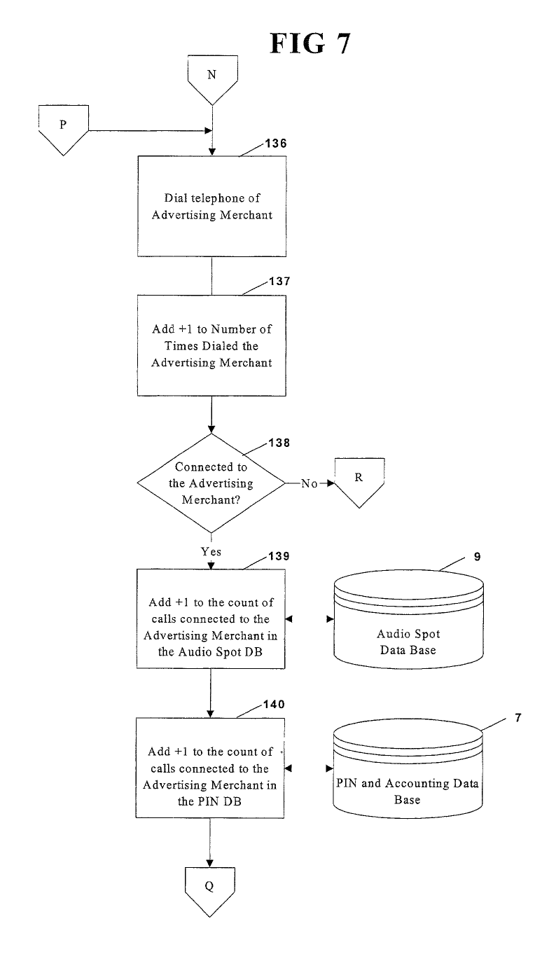

FIG. 7 illustrates the process for connection to the Audio Services Provider/Owner and the call accounting processes for storing the results of the call process. The telephone switch 5 connects the call to the telephone number of the Services Provider/Owner (step 136), and increments by 1 the number of times the merchant has been dialed (step 137). Switch 5 then checks to see if the connection has been made to the Services Provider/Owner (step 138). The server 6 then increments by 1 the count of the number of calls connected to the Services Provider/Owner in the Audio Services Database (step 139), and increments by 1 the count of calls connected to the Audio Services Provider/Owner in the PIN Database (step 140). This process may involve connecting the user's telephone 1 or 3 to a service center or telemarketing center 14, but could also include connection to other communications systems, manned or unmanned, as long as the Service Provider's communications system can communicate with the user via voice or video prompts and inputs available via the user's telephone 1 or 3. The types of services provided can also vary, from offering products for sale or lease, to offering services or other intangibles for purchase by the user. Preferably one will keep track of the Audio Spots played to the customer base as a whole (step 139), and keep track of the number of times that a customer is connected to the Advertiser, at the customer level, via the PIN and Accounting Data Base (step 140).

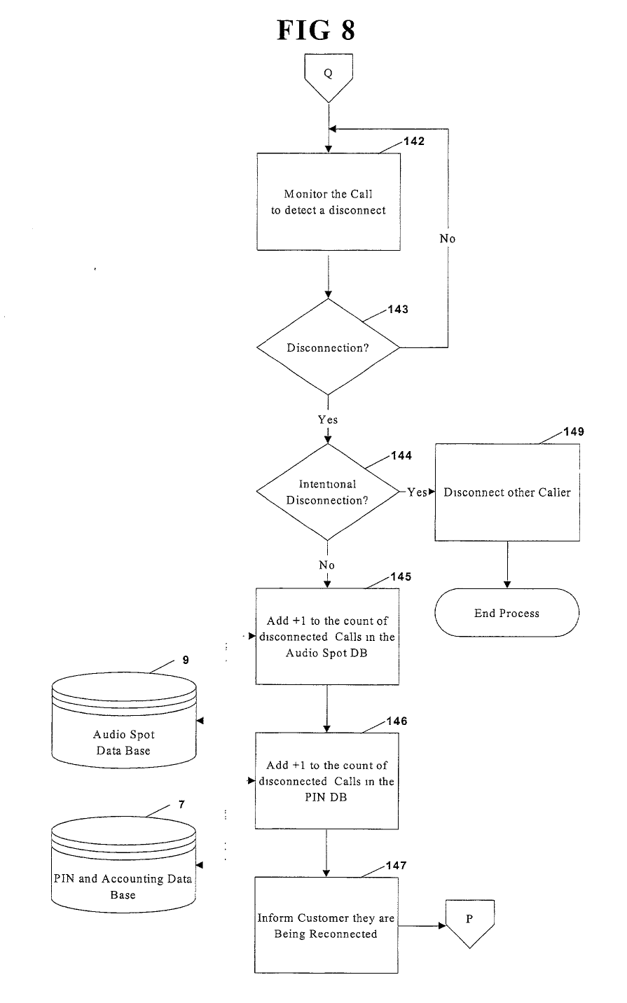

In FIG. 8, a call is monitored to detect a disconnect. The telephone switch 5 monitors the call to detect a disconnect (step 142); if there is a disconnection (step 143) switch 5 evaluates whether it is an intentional disconnection (step 144). If not, server 6 increments by 1 the count of disconnected calls in the Audio Services database (step 145) and the PIN and accounting database (step 146), and informs the customer that they are being reconnected (step 147). If the disconnection was intentional, the telephone switch disconnects the other caller (step 149).

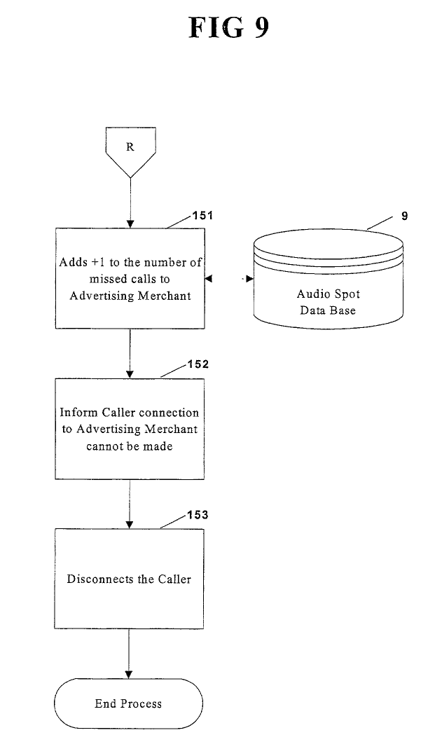

FIG. 9 illustrates one of the call accounting sequences. The server 6 increments by 1 the Audio Services Database (step 151), indicating that the Audio Services Provider/Owner did not answer the inbound call from the calling party. The server 6 then prompts the Audio Response Unit 8 to inform the calling party that a connection to the Audio Services Provider/Owner cannot be made (step 152), and disconnects the call (step 153).

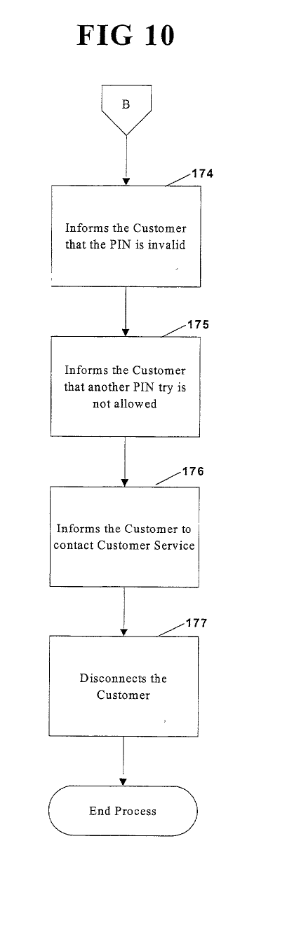

FIG. 10 illustrates steps that are taken when the calling party enters an invalid PIN at least three time (or other maximum number of tries). The server 6 prompts the audio response unit 8 to inform the calling party that they have entered an invalid PIN (step 174); optionally, the server may also inform the caller that additional attempts to enter a PIN are not allowed (step 175). The server 6 may then prompt the audio response unit to inform the calling party to contact a Customer Service unit (step 176), and then disconnects the call (step 177).

It is believed that the operation and construction of the present invention will be apparent from the foregoing description. While the method, apparatus and system shown and described has been characterized as being preferred, it will be readily apparent that various changes and modifications could be made therein without departing from the scope of the invention as defined in the following claims, and that the invention is not limited to these embodiments. For example, those skilled in the art will appreciate how each of the elements of the aforementioned embodiments may be utilized alone or in combination with elements of the other embodiments. Thus, modifications may be made by those skilled in the art, particularly in light of the foregoing teachings, without departing from the scope of the invention.

I claim:

1. A method of providing advertising services to a user of pre-paid communications services via a first communications unit capable of two-way audio communications, comprising:
(a) receiving a personal identifier input from the user of the first communications unit;
(b) determining based on the personal identifier if the user is authorized to communicate with a further communication unit;
(c) sending a first message advertising a service to the first communications unit based on the personal identifier;
(d) receiving a reply in response to the first message indicating whether the user wants to receive further information about the offered service.

2. The method of claim 1, further comprising:
(e) in response to the reply of step (d), putting the first communications unit in communication with a provider of further information about the offered service.

3. The method of claim 1, further comprising:
(e) putting the first communications unit in communication with the further communications unit; and
(f) after the first communications unit has ceased communications with the further communications unit, putting the first communications unit in communication with a provider of further information about the offered service.

4. The method of claim 1, wherein the first communications unit is a telephone, the personal identifier is a personal identification number (PIN), step (b) further comprising determining in a server, based on the PIN, whether the user is authorized to communicate with the further communications unit and, if authorized, what content to send to the first communications unit as the first message.

5. The method of claim 4, wherein step (c) comprises sending an audio spot advertisement containing information about a product offer.

6. The method of claim 5, wherein the offered service is an offer to sell a product and the audio spot advertisement includes identification of a prompt signal to use if further information is wanted by the user, and step (d) comprises receiving the prompt signal as the reply, and placing the user in communications with a customer service entity to provide the further information about the product.

7. The method of claim 4, wherein the first message is only sent once during a communications session.

8. The method of claim 4, wherein multiple audio spot ads are used as the content and each of the multiple audio spot ads is only sent one time during a predetermined period.

9. The method of claim 8, further comprising the step of saving use information about each of the multiple spot ads sent in connection with the PIN.

10. The method of claim 4, wherein multiple audio spot ads are used as the content, and comprising the further steps of sending a prompt as an indication that the user wants to be sent a further audio spot ad, receiving a prompt reply in response to the prompt, and sending the further audio spot ad to the first communications unit.

11. The method of claim 10, wherein the further audio spot ad is a longer message about the same product as the first message.

12. A system for selectively providing advertising to a user of prepaid communications services, comprising:
(a) a user data store, capable of storing and retrieving remaining value information for personal identifiers;
(b) an ad data store, capable of storing and providing ad information in response to a communications request including at least one personal identifier; and
(c) a network communications processor, in communications with the user data store and ad data store, capable of accepting a communications request including a first personal identifier from a first communications unit and determining whether to place the first communications unit in communications with a further communications unit based on a first remaining value information of the first personal identifier, and providing a first ad from the ad data store to the first communications unit based on the first personal identifier before placing the first communications unit in communications with the further communications unit.

13. The system of claim 12, wherein the first and further communications units are a first and further telephone, the first personal identifier is a PIN, and the network communications processor comprises a telephone activity management server in networked communications with the user data store and ad data store.

14. The system of claim 13, the network communications processor further comprising a switch and a response unit, wherein the switch is in networked communications with the telephone activity management server and the response unit, the response unit is in further networked communications with the telephone activity management server and the ad data store, and the switch is capable of placing the first telephone in communications with the second telephone based of the first remaining value information of the PIN.

15. The system of claim 14, wherein the telephone activity management server comprises:
(a) a PIN Validation Director that verifies, in response to the communications request, whether the first remaining value information of the PIN is at least a minimum predetermined value for placing the first telephone in communications with the further telephone;
(b) an Ad Director that forwards the first ad to the first telephone in response to a verification of the first remaining value information, and controls the switch to place the first telephone in communication with the second telephone after a prompted reply is received by the switch in response to the first ad.

16. The system of claim 13, the network communications processor further comprising a router and a response unit, wherein the switch is in networked communications with the telephone activity management server and the response unit, the response unit is in further networked communications with the telephone activity management server and the ad data store, and the router is capable of placing the first telephone in communications with the second telephone based of the first remaining value information of the PIN, wherein the telephone activity management server comprises:
(a) a PIN Validation Director that verifies, in response to the communications request, whether the first remaining value information of the PIN is at least a minimum predetermined value for placing the first telephone in communications with the further telephone; and
(b) an Ad Director that forwards the first ad to the first telephone in response to a verification of the first remaining value information, and controls the router to place the first telephone in connectionless communication with the second telephone after a prompted reply is received by the router in response to the first ad.

17. The system of claim 16, further comprising an audio response unit in networked communications with the router, telephone activity management server and ad data store, the audio response unit being responsive to the Ad Director to provide the first ad to the router in a form that when received at the first telephone provides a user intelligible audio message, the audio response unit being further configured to receive audio prompt information from the first telephone and provide prompt data to the ad director.

18. The system of claim 17, wherein the Ad Director operates, in response to prompt data indicating further ad information has been requested by the user, to control the router to place the user in communication with a service provider providing services promoted in the first ad.

19. A communications program for providing audio advertising to a user of a prepaid communications service, the program operable to control a network communications processor, the program comprising:
(a) a PIN Validation Director having logic to verify, in response to a communications request from a first telephone including a PIN, whether a remaining value associated with the PIN is at least a minimum predetermined value for placing the first telephone in communications with a second telephone; and
(b) an Ad Director having logic to forward a first ad to the first telephone in response to a verification of the first remaining value.

20. The communications program of claim 19, wherein the Ad Director has further logic to control the network communications processor to send the first ad to the first telephone after its communications with the second telephone have terminated.

21. The communications program of claim 19, wherein the Ad Director has further logic to control the network communications processor to place the first telephone in communication with the second telephone after a prompted reply is received by the network communications processor in response to the first ad.

22. The program of claim 21, further comprising:
(c) a Communications Monitor, having logic to monitor the communications between the first and second telephones and, when said communications terminate, to place the first telephone in communication with a service provider associated with the first ad.

23. The program of claim 22, further comprising:
(d) an Audio Response Routine, having logic to (i) retrieve the first ad from a data store and convert it into a form that when received at the first telephone provides a user intelligible audio message, and (ii) receive audio prompt information from the first telephone and convert it to prompt data, wherein the ad director has further logic to determine whether to place the first telephone in communication with the service provider based on the prompt data.

24. A method of providing advertising services to a user of pre-paid communications via a communications unit capable of two-way audio communications, comprising:
(a) entering via a user interface on the communications unit a unique identifier;
(b) communicating the unique identifier to a network communication processor;
(c) receiving at the communications unit, in response to the communicated unique identifier, a first message advertising the availability of an offered service;
(d) entering via the user interface a response indicating more information should be communicated to the communications unit concerning the offered service; and
(e) receiving at the communications unit further information about the offered service.

25. The method of claim 24, wherein the first message is an audio product advertisement, and step (c) comprises communicating the audio product advertisement via a speaker of the communications unit.

26. The method of claim 24, wherein the first message includes a visual advertisement, and step (c) comprises communicating the visual advertisement via a visual display device of the communications unit.

27. The method of claim 26, wherein the visual display device is a touch screen, the first message includes a first symbol to press on the touch screen in order to receive more information, and step (d) comprises pressing the first symbol.

28. The method of claim 24, wherein the unique identifier is a PIN, the communications unit is a telephone, and step (a) comprises entering the PIN via a touchtone key pad of the telephone.

29. The method of claim 28, wherein the first message includes an indication of a first touchtone key to press in order to receive more information, and step (d) comprises pressing the first touchtone key.

30. The method of claim 28, step (b) further comprising communicating an address for the network communication processor, wherein the address and PIN are determined by the user from information on a pre-paid phone card.

31. The method of claim 28, wherein the network communication processor is a switch and step (b) further comprises communicating a toll free telephone number for the switch, wherein the telephone number and PIN are determined by the user from account information for a card.

32. The method of claim 24, further comprising: prior to step (c), entering via the user interface a destination communications unit identifier identifying a second communications unit; and after step (d) commencing communications with the second communications unit.

33. The method of claim 32 wherein the first message is an audio product advertisement and the further information includes detailed purchase information about a product received from a call center, the method further comprising:
(f) communicating an acceptance of the offered product via the user interface.

34. A method of providing advertisements to a user of pre-paid telephony services comprising:
(a) entering via a user interface on a first phone a unique identifier and a further identifier for a second phone;
(b) communicating the unique identifier and further identifier to a network service provider;
(c) receiving a first advertisement at the first phone in response to the communicated unique identifier;
(d) entering a response indicating further information related to the advertisement should be communicated to the first phone;
(e) establishing communications with the second phone; and
(f) receiving at the first phone the further information.

35. The method of claim 34, wherein the unique identifier is a Personal Identification Number (“PIN”), the user interface is one of a dial pad, a telephone microphone or a touch sensitive display, and the first phone is at least one of a wireline phone or a wireless phone.

36. The method of claim 35, further comprising prior to step (a): entering a service number to establish communications with the network service provider.

37. The method of claim 36, wherein step (f) follows step (e) and further comprises placing an order for one of a product or a service in response to the further information.
